(19) United States
(12) Patent Application Publication
(10) Pub. No.: US 2007/0204090 A1
(43) Pub. Date: Aug. 30, 2007

(54) Method and apparatus for routing of control lines

(76) Inventor: Yann Casteignau, Choisel (FR)

Correspondence Address: CANTOR COLBURN, LLP, 55 GRIFFIN ROAD SOUTH, BLOOMFIELD, CT, 06002, US

(21) Appl. No.: 11/253,424

(22) Filed: Oct. 19, 2005

(30) Foreign Application Priority Data
Nov. 24, 2004 (FR) 04 52751

(51) Int. Cl. G06F 13/12; G08C 19/00; G06F 13/38; G06F 13/14

(52) U.S. Cl. 710/305; 710/70; 710/71; 340/825.62

(57) ABSTRACT

Control lines for routing in which senders and receivers are linked to each other by real-time lines and real-time signals observable on these lines are sent out in series in a frame, on one and the same series link. Starting and ending signals of a particular shape are send with the real-time signals on the link so as to facilitate especially a detection of errors, a synchronization between senders and receivers and an evolution of the system in terms of number of real-time lines, without modifying its cabling.

### CROSS-REFERENCE TO RELATED APPLICATIONS

This application claims the benefit of a priority under 35 USC 119(a)-(d) to French Patent Application No. 0452751 filed Nov. 24, 2004, the entire contents of which are hereby incorporated by reference.

### BACKGROUND OF THE INVENTION

An embodiment of the present invention relates to a method and apparatus for routing control lines, and in particular, for example, in a medical system, such as an X-ray apparatus.

In a medical system or apparatus, there are prior art methods to control different elements by means of control lines. A medical system or apparatus has numerous receivers, such as a generator for an X-ray tube, or motors, that communicate with sending units or senders by means of control lines. These control lines are characterized by their reaction speed, their robustness and the time needed for a receiver to decode the signals carried.

To make a sender and a receiver communicate, RS232 or CAN (Control Area Network) type protocol communication lines, for example, are used. The signals observable on these communication lines take a certain amount of time to be decoded by receivers. Through the communications protocol, the integrity of all the signals traveling through the line is verified. Furthermore, the protocol authorizes a new transmission when there are sending or reception problems. Consequently, the response time of such lines is not ensured. A piece of information associated with the signal conveyed by the protocol line is said to be information of the software type.

In the case of receivers of critical importance, such as emergency stop buttons, it is imperative to know the response time of a line. Other communication lines, called real-time lines, for which there is a time-related specification, are therefore implemented. The response time of these real-time lines is short and deterministically known. These real-time lines thus enable the critically important receivers to be controlled precisely and rapidly, leaving no room for controls based on an approximate approach whose consequences could be disastrous. These real-time lines, which are also known as “hardware”, can also be used to deactivate a process (through “hardware redundancy”) in a way that is de-correlated from a general scheme or a general functioning of the medical system.

For this purpose, a real-time line is reserved for the control of a receiver by one or more senders. Thus, the real-time signals corresponding to several receivers are sent in parallel on different real-time lines. Furthermore, to obtain maximum robustness, the observable signals on a real-time line are generally of the “all-or-nothing” type. These signals thus make unencrypted transmission of a piece of control information to a receiver and prevent erroneous transmissions to the maximum extent. The information associated with the signal carried by the real-time line is known as “hardware” type information.

In general, existing medical systems or apparatus set up redundancy between software type information and hardware type information. The sender and the receiver are often connected to one another, not only by means of a real-time line but also by means of a protocol communications line. Thus redundancy provides for robust communication between a sender and a receiver. In one example, when a practitioner activates an X-ray emission sequence, an exchange of signals takes place between the transmitter (the command) and the X-ray system by means of a protocol communications line. At the same time as this exchange of signals occurs, a signal is sent on the real-time line. This signal sent on the real-time line confirms and activates the X-ray sequence.

Medical systems or apparatus using real-time and protocol communications methods function well but have limits as regards the management of real-time lines. Owing to the exclusive character of the use of a real-time line with its receiver, for a number N of receivers, a number N of real-time lines is brought into play. Now each of these real-time lines physically corresponds to one or more wires. The known systems or apparatus that comprise numerous receivers therefore have numerous wires. This makes it difficult to set up a link or an assembly between transmitters and receivers. Furthermore, cables grouping several lines together have numerous conductors. The cables therefore have a big diameter and are therefore fragile.

Furthermore, a medical system or apparatus is designed and structured according to the number of real-time lines used. Hence, if a system or apparatus evolves, it becomes difficult to modify it without a modification having an impact on the structure of the systems already manufactured or being manufactured. Indeed, in one example, when new receivers have to be integrated, it is often necessary to modify electronic circuits and the entire structure of the communication lines of the medical system.

Furthermore, in a system or apparatus where the real-time signals are sent in parallel, it is difficult to detect connection problems. In the event of a break in a wire or a poor connection, all the elements transmitted by these lines take a state that corresponds to a particular state of the system. Now there is nothing planned to show that the signals are in an unusual or abnormal state.

### BRIEF DESCRIPTION OF THE INVENTION

An embodiment of the method and apparatus is to provide a more robust arrangement, while at the same time facilitating the future development of the system. An embodiment of the invention therefore proposes to resolve the problem of the future development of the number of real-time lines, while reinforcing their robustness.

In an embodiment of the invention, the real-time signals are sent on one and the same physical link in a particular way. More specifically, the observable signals are sent on the different real-time lines in series, by means of a data serializing module or serializer. The signals sent in a series signal are sent in parallel by means of a data deserializing module or deserializer. Real-time signals travel on only one physical link makes it possible to reduce the space requirement of the real-time lines and makes the use of the medical system or apparatus more flexible.

In one embodiment, N real-time signals that had been sent in parallel are sent in series, one after the other, in frames each comprising N+2 signals, on one and the same dedicated physical link. Since the serializer that carries out this serializing operation comprises flip-flop circuits and logic gates, the latency time for this serialization of the real-time signals is known with precision. The fact of being able to know this latency time means that it is possible to precisely determine a point in time at which a real-time signal is received by a receiver. This determining makes it possible to ensure predictable and robust conveyance of the real-time signals.

Furthermore, in an embodiment of the invention, a starting and ending signal of a particular shape is sent inside frames observable on the dedicated physical link. These signals make it possible especially to automatically synchronize a serializer and a deserializer with each other, and automatically compute the number of signals transmitted on the series line. This computation of the number of signals transmitted creates high adaptability of the system, since the addition of an additional receiver can be directly detected. It is thus possible to make a medical system or apparatus in terms of numbers of real-time lines without modifying its wiring.

An embodiment of the invention provides a method for routing of control lines, and in particular for the routing of real-time lines between a serializer and a deserializer, comprising: an output of the serializer is connected with an input of the deserializer by means of a series link; a first real-time data signals observable on first real-time lines are applied in parallel to inputs of the serializer; the serializer sends the first signals successively in time in the form of second signals on the series link; the deserializer extracts the second signals and sends them in the form of third signals on second real-time lines that correspond to them.

### BRIEF DESCRIPTION OF THE DRAWINGS

The invention will be understood more clearly from the following description and the accompanying figures. These figures are given by way of an illustration that in no way restricts the scope of the invention. Of these figures:

FIG. 1 is a schematic view of an X-ray machine in which an embodiment of the method can be implemented;

FIG. 2 is a schematic view of an implementation of an embodiment of the method, with several serializers and several deserializers connected to one and the same bus;

FIG. 3a is a schematic view of an embodiment of the method for placing real-time signals in series and in parallel;

FIG. 3b is a schematic view of a frame of a series signal according to an embodiment of the invention comprising a starting signal and an ending signal of a particular shape; and

FIG. 4 is a schematic view of two systems used to route real-time lines according to an embodiment of the invention.

### DETAILED DESCRIPTION OF THE INVENTION

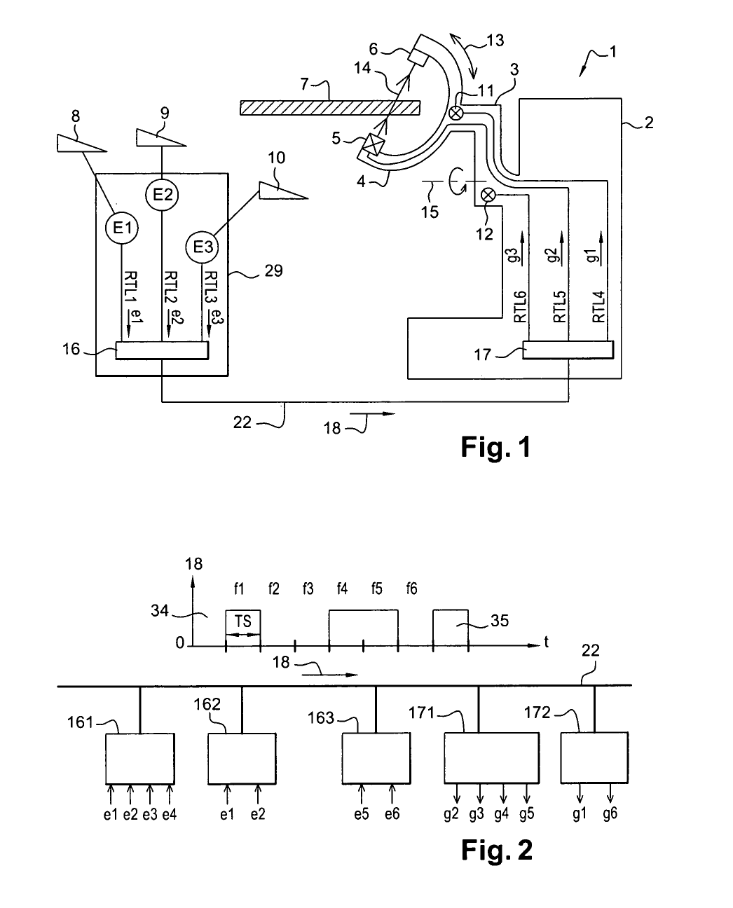

FIG. 1 shows an X-ray apparatus 1 comprising a pedestal 2, an intermediate arm 3 and a C-shaped arm 4. The intermediate arm 3 is connected to the pedestal 2 and to the arm 4. Means for providing a source of radiation, such as an X-ray emitter 5 and means for detecting the emitted radiation, such as an X-ray detector 6, are hooked to the arm 4, opposite each other. Furthermore, the detector 6 is in the axis of a beam 14 emitted by the emitter 5. A table 7 is fixed and located inside the C shape of the arm 4. This table 7 is positioned so that the emitter 5 and the detector 7 are located respectively at the bottom and top of the table 7.

Means for actuation, such as three actuators 8-10, such as pedals or levers, are used to respectively command a first motor 11, the emitter 5 and a second motor 12. More specifically, the actuator 8 is used to command the first motor 11 that makes the arm 4 rotate, generally about the center of the beam 14 along the arrow 13. The actuator 9 is used to command emission by the X-ray emitter 5. The actuator 10 is used to command the motor 12 that makes the intermediate arm 3 rotate, generally about an axis 15 that is horizontal and perpendicular to a face of the pedestal 2. The X-ray emitter 5, the first motor 11 and the second motor 12 shall more generally be indicated as means for receiving in this application.

In order to control the means for receiving, the actuators 8-10 are respectively connected to emitters E1-E3. Emitters E1-E3 are connected to a serializer 16 by means of first real-time lines RTL1-RTL3. The first lines RTL1-RTL3 are parallel-connected to inputs of a serializer 16. A deserializer 17 is connected to the system 16 by means of a series link 22. Second lines RTL4-RTL6 are connected to outputs of the deserializer 17 and to the receivers 5, 11 and 12. Each of these second lines RTL4-RTL6 is connected to the receiver that corresponds to it.

Three different first data signals e1-e3 are respectively observable on three first real-time lines RTL1-RTL3. The serializer 16 sends these first signals e1-e3 in series in the form of second signals f1-f3 (not shown) in a series signal 18 observable on the link 22. Series signal 18 is applied as an input to the deserializer 17 which extracts the second signals and sends them out in the form of third signals g1-g3 observable at the outputs of the deserializer and hence on the second real-time lines RTL4-RTL6. Third signals g1-g3 respectively corresponds to the first signals e1-e3.

In one embodiment, the emitters E1-E3 and the serializer 16 are connected to one and the same emitter circuit 29. This enables the emitter circuit 29 and the receivers 5, 11, 12 to communicate by means of the series link 22, whereas in a classic system, three links would have been necessary.

As a variant, several actuators can be connected to one and the same emitter. Each actuator can then activate the emitter to which it is connected independently of the other actuators.

An embodiment of the invention is implemented on an X-ray machine, but it could equally well be implemented on other medical systems such as vascular tables, mammography machines, systems implementing tomography methods, etc.

FIG. 2 shows an architecture known as a multicast architecture. In this architecture, three serializers 161-163 and two deserializers 171-172 are connected to a same series link 22 that, in this case, is a bus. More specifically, outputs of the serializers 161-163 are connected to the bus 22, while inputs of the deserializers 171-172 are connected to this bus 22.

First signals e1-e6 can be observed on six distinct real-time lines. The first signals e1-e4 are applied to input terminals of the first serializer 161. The first signals e1 and e2 are applied to input terminals of the second serializer 162. The first signals e5 and e6 are applied to input terminals of the third serializer 163. These first signals e1-e6 are sent in series in a series signal 18 observable on the bus 22 at output of the serializers 161-163. This series signal 18 comprises frames formed by second signals f1-f6. These second signals f1-f6 correspond to the first signals e1-e6 at given points in time. Generally, the second signals f1-f6 are each sent with a same duration TS.

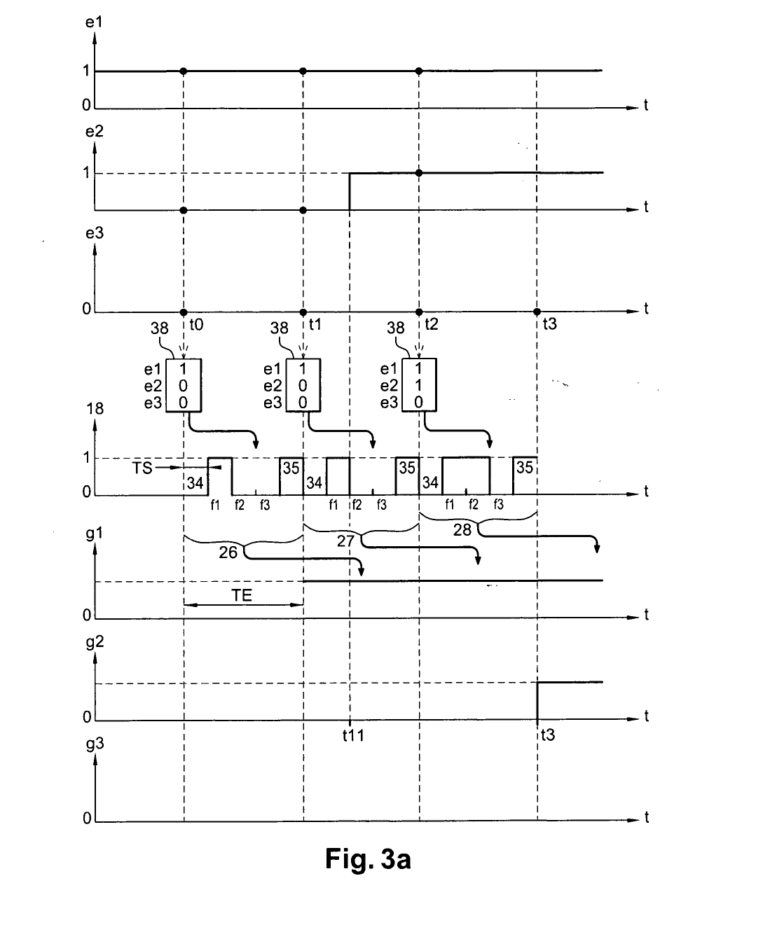

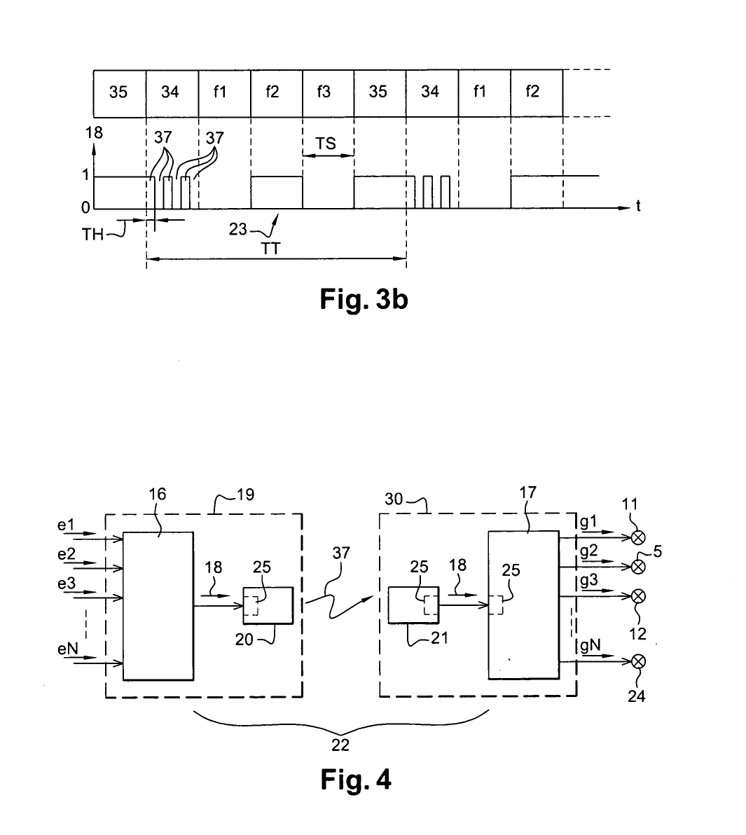

To synchronize the serializing of the first signals e1-e6, the first serializer 161 acts as a master serializer. The serializer 161 sends a starting signal 34 and/or an ending signal 35 that sandwich the other signals f1-f6. The serializers 162 and 163 are locked into the starting and ending signals 34, 35 to send the second signals associated with them in a frame of the series signal 18. The serializing of the first signals e1-e6 is explained in greater detail in FIG. 3a.

The series signal 18 is applied as an input to the deserializers 171 and 172. These deserializers 171 and 172 convert the second signals f1-f6, sent in series, into third signals g1-g6 sent in parallel. Indeed, from the series signal 18, the deserializer 171 extracts the second signals f2-f5 so as to send them on four distinct lines in the form of third signals g2-g5. And the second deserializer 172 extracts the signals f1 and f6 so as to send them on two distinct lines in the form of third signals g1 and g6.

In one embodiment, the first, second and third signals have either a level called a recessive level or a level called a dominant level. A signal of recessive level can be modified by a signal of dominant level, while a signal of dominant level cannot be modified by a signal of recessive level. As a rule, a recessive level corresponds to an idle level. In one example, the recessive and dominant levels are imposed by means of open-collector transistors. A conductive state of these transistors applies a level 0 to the line (dominant state), while an off state of these transistors leaves the line in a state biased by a resistor connected to a non-zero potential, this resistor being called a pull-up resistor (recessive state).

The first signal e1 is observable at input of the serializers 161 and 162. Thus, the dominant level of the second signal f1 can be imposed either when the first signal e1 of the first serializer 161 has a dominant level or when the first signal e1 of the second serializer 162 has a dominant level. This is also true for the signal e2 that is observable at input of the first and second serializer 161 and 162. The multiplying of the first signals e1 or e2 is particularly worthwhile when several transmitters controlling a same receiver are located at different places in an examination room.

In this example, six first signals e1-e6 are applied to the inputs of three serializers 161-163, and two deserializers 171-172 deserializing the series signal 18. However, in general, N first signals can be applied to inputs of M serializers, and P deserializers can carry out a deserialization of the series signal 18.

FIG. 3a provides schematic views of first signals e1-e3, a series signal 18 formed by frames 26-28, and third signals g1-g3. The high levels (logic 1) of signals correspond to the above-mentioned dominant levels, while the low levels (logic 0) correspond to the above-mentioned recessive levels. The first signals e1-e3 represented are observable at the inputs of the serializer 16. These first signals e1-e3 are sampled regularly at a sampling frequency corresponding to 1/TE.

At the time of a sampling, the level of the first signals e1-e3 is stored within a memory 38. At instant t0, the first signals e1-e3 respectively possesses a logic 1 level, a logic 0 level and a logic 0 level. At the instant t1, the first signals e1-e3 respectively posses a logic 1 level, a logic 0 level and a logic 0 level. At instant t2, the first signals e1-e3 respectively posses a logic 1 level, a logic 1 level and a logic 0 level.

During the period between two successive sampling operations, for example, the first signals e1-e3 are sent serially in a frame 26, 27 or 28 in the form of second signals f1-f3. These second signals f1-f3 are sent with a same signal duration TS. However, as a variant, they could be sent with different durations. The frequency of serializing the first signals e1-e3 corresponding to 1/TS is equal to 250 kHz in one example. As a rule, a serializing frequency of 200 kHz to 300 kHz is chosen.

After having been serialized in the form of second signals f1-f3, the real-time signals are deserialized and sent again in parallel in the form of third signals g1-g3. The time of this deserialization may be as soon as the serialization of the first signals is ended, that is upon the sending of a full frame 26, 27 or 28, or after the sending. In one example, this deserialization occurs at the time of a new sampling.

In frames 26-28, the second signals f1-f3 are sandwiched by a starting signal 34 and an ending signal 35 sent, if need be, by a master serializer. The starting signal 34 enables the deserializer 17 to compute the position of each second signal f1-f3 in a frame, in order to send the three signals g1-g3 in parallel in a particular order. Indeed, in one example, the deserializer 17, using a micro-controller, can compute the relative position of the second signals f1-f3, as a function of the position of the starting signal 34 and/or of the ending signal 35. From the determining of the position of the second signals f1-f3, the third signals g1-g3 can respectively be sent on the second real-time lines corresponding to them.

There may be a time lag between the first signals e1-e3 and the third signals g1-g3. Indeed, it may be noted that the change in level of the first signal e2 that occurs before the instant t2, at the instant t11, is observable in the third signal g2 only at the instant t3. This change in level can be detected in the worst case after twice the lapse of the duration of the sampling period TE. The worst case for the time lags between the first signals e1-e3 and the third signals g1-g3 is therefore constant in time; it is known and it is short. In one embodiment, it is seen to it that the duration corresponding to the worst lags is far smaller than a response time of the receivers. In one example, this duration is 10 times shorter than a response time of the receivers.

The starting signal 34 and the ending signal 35 possess opposite levels. For example, the starting signal 34 has a dominant level, while the ending signal 35 has a recessive level. Thus, the detection or non-detection of an edge between the starting signal 34 and the ending signal 35 enables the detection of a wiring problem. Indeed, should there be no wiring problem, this edge is detected at the latest after three times the lapse of the signal duration TS. However, when a problem arises, for example the breaking of a break of a cable, no edge is detected.

In an exemplary embodiment, a coherence signal such as a signal (not shown) corresponding to the one's complement of the second signals (f1-f3) is produced in the frames of the signal 18. It will be seen in FIG. 4 that this coherence signal can be used with verification modules 25.

The serialization method described is implemented when the serializer 16 and the deserializer 17 know their reciprocal rhythm. In order to exchange the frames 26-28, the serializer 16 and the deserializer 17 must have the same speed of communication corresponding to the frequency of serializing of the first signals e1-e3.

FIG. 3b shows a view of a frame 23 of the series signal 18 enabling the serializer 16 and the deserializer 17 to communicate, even when they do not have an identical communication speed at the outset. The series signal 18 is very similar in this figure to the one described in FIG. 3a. The second signals e1-e3 are sent in series in the frame 23 and are sandwiched by a starting signal 34 and an ending signal 35. However, in this variant, the starting signal 34 has several differences in level. The starting signal 34 thus has six half-waves 37. Each half-wave 37 has a duration equal to one period of a clock signal, called a clock signal period TH. In one example, the clock signal is a signal of fixed frequency 1/TH applied to one of the inputs of the serializer 16 and the deserializer 17.

From the half-waves 37, the deserializer 17 can compute the duration of the second signals f1-f3 that are sent to it. In this case, all the second signals f1-f3 of the frame 23 are sent with a same signal duration TS. The deserializer 17 can therefore compute this duration TS as a function of the number of half-waves of the starting signal 34 and the duration of the clock period TH. Here, the deserializer 17 finds by computation that the second signals f1-f3 sent to it possess a signal duration TS equal to six times the duration of a clock period TH.

As a consequence, after having completely received a starting signal 34, a deserializer 17 can get automatically locked to the serializing frequency of the serializer 16. This serializing frequency corresponds to 1/TS. In one example, the locking is achieved in a step for resetting a medical system.

As a variant, the starting signal 34 and the second signals f1-f3 are sent with different durations. In this variant, the duration of each signal is computed from a known ratio between the duration of the starting signal 34 and the durations of the second signals f1-f3. As a variant, the half-wave signals 37 are imposed within the ending signal 35.

Furthermore, in detecting two successive starting signals 34, the deserializer 17 can compute the number of second signals f1-f3 corresponding to the number of receivers implemented. More specifically, in one implementation, a frame duration TT between the two successive starting signals 34 is measured. Then, the ratio of the frame duration TT to the signal duration TS is taken and the two signals, namely the starting and ending signals 34 and 35, are subtracted from this number of signals. Then, the number of first and third signals corresponding to the number of real-time lines used is obtained.

Thus, starting from the time when the deserializer 17 receives the frame 23, it can automatically detect a new development of the medical system. With such a method, it is therefore possible to add additional senders and receivers by simply connecting these senders and these receivers respectively to inputs of the serializer 16 and outputs of the deserializer 17 left free and set aside for this purpose.

In one particular embodiment, the frame duration TT is equal to the sampling period TE. As a variant, the ending signal 35 may be identified with the starting signal 34 of the next frame. As in the previous figure, the frame 23 has been represented for three second signals f1-f3. However, in general, N signals can be sent between the starting signal 34 and the ending signal 35.

FIG. 4 shows an exemplary embodiment of two systems 19 and 30 used to route real-time lines. In this embodiment, the first system 19 comprises the serializer 16 and a first communications circuit 20. The second system 30 comprises a deserializer 17 and a second communications circuit 21. The communications circuits 20 and 21 form the series link 22 and provide especially for the conveyance of a signal in a particular shape.

More specifically, in this embodiment, N first signals e1-eN are applied to the inputs of the serializer 16. At one output terminal of the serializer 16, there is observed a series signal 18 that is applied as an input to the first communications circuit. This first communications circuit 20 modifies the shape of the series signal 18 in order to reliably transport this signal to the second communications circuit 21. In one example, the series signal 18 is a TTL type signal that is converted into an optical type of transmission signal 37. As a variant the TTL type signal 18 is converted into a transmission signal 37 of a 0-24V type or into a differential transmission signal 37. The 0-24V type signals and the differential signals give a certain degree of immunity to the information conveyed relative to external signals.

The transmission signal 37 is then applied as an input to the second communications circuit 21. Since this second communications circuit 21 provides for the reverse conversion of the first communications circuit 20, the series signal 18 is again observed at its output. This series signal 18 is applied as an input to the deserializer 17. This deserializer 17 then converts the signal 18 into N third parallel signals g1-gN observable at its output. These N third signals g1-gN are then applied to the N receivers 11, 5, 12 and 24 to which they correspond.

In one example, the serializer 16 and the deserializer 17 are formed by FPGA type electronic circuits and/or logic gates and/or flip-flop circuits.

In one embodiment, verification modules 25 are used to verify the integrity of the frames of the series signal 18. Thus, modules 25 may be connected to the input of the first circuit 20, the output of the second circuit 21 and the input of the deserializer 17. In one example, these modules 25 may compare a consistency signal, associated with received frames, with the above-mentioned consistency signal associated with the observable frame at output of the serializer 16. In one example, this comparison is made by means of comparator circuits comprising operational amplifiers.

Whenever a frame error is detected, an alarm may be sent out in order to warn a user of this error. The medical system can then be stopped or placed in a security state. In this security state, particular levels are assigned to the different signals of the system in order to prevent elements of the system from being in a state of operation that may be dangerous to the practitioner or the patient.

Naturally, the serialization method described can be combined with a communications method implementing communications protocols according to the Control Area Network (CAN) standard for example. This combination can be used to augment the robustness of the exchanges of signals between the senders and receivers of the medical system.

In addition, while an embodiment of the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof with respect to structure/way and/or function and/or result. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of routing control lines for real-time lines between a serializer and a deserializer comprising:
connecting an output of the serializer with an input of the deserializer by means of a series link;
applying in parallel first real-time data signals observable on first real-time lines to inputs of the serializer;
causing the serializer to send the first signals, successively in time, in the form of second signals on the series link; and
causing the deserializer to extract the second signals and send them in the form of third signals on corresponding second real-time lines.

2. The method according to claim 1 wherein on the series link, the second signals are sent in a frame of a series signal.

3. The method according to claim 2 wherein
the serializer sends a starting signal and an ending signal in the frame of the series signal; and
the serializer sends the second signals between the starting signal and the ending signal.

4. The method according to claim 3 wherein the serializer sends the starting signal and/or the ending signal with opposite levels.

5. The method according to claim 3 wherein
different signal levels are imposed inside the starting signal, in imposing half-waves on it; and
for a given shape of the starting signal, a signal duration is measured for it.

6. The method according to claim 4 wherein
different signal levels are imposed inside the starting signal, in imposing half-waves on it; and
for a given shape of the starting signal, a signal duration is measured for it.

7. The method according to claim 5 wherein
a frame duration between two starting signals is measured; and
the number of first signals and third signals transported is measured by the ratio of the frame duration to the signal duration, and the third signals are sent on a number of lines corresponding to the number of signals.

8. The method according to claim 6 wherein
a frame duration between two starting signals is measured; and
the number of first signals and third signals transported is measured by the ratio of the frame duration to the signal duration, and the third signals are sent on a number of lines corresponding to the number of signals.

9. The method according to claim 3 wherein the second signals, the starting signal and the ending signal are sent with a same signal duration.

10. The method according to claim 4 wherein the second signals, the starting signal and the ending signal are sent with a same signal duration.

11. The method according to claim 5 wherein the second signals, the starting signal and the ending signal are sent with a same signal duration.

12. The method according to claim 7 wherein the second signals, the starting signal and the ending signal are sent with a same signal duration.

13. The method according to claim 2 wherein the second signals are sent in series in the frame at a frequency of 250 kHz.

14. The method according to claim 3 wherein the second signals are sent in series in the frame at a frequency of 250 kHz.

15. The method according to claim 4 wherein the second signals are sent in series in the frame at a frequency of 250 kHz.

16. The method according to claim 5 wherein the second signals are sent in series in the frame at a frequency of 250 kHz.

17. The method according to claim 7 wherein the second signals are sent in series in the frame at a frequency of 250 kHz.

18. The method according to claim 9 wherein the second signals are sent in series in the frame at a frequency of 250 kHz.

19. The method according to claim 1 wherein
several serializers and several deserializers are connected to a same series link; and
several first signals corresponding to a same first real-time line are applied to inputs of different serializers.

20. The method according to claim 2 wherein
several serializers and several deserializers are connected to a same series link; and
several first signals corresponding to a same first real-time line are applied to inputs of different serializers.

21. The method according to claim 3 wherein
several serializers and several deserializers are connected to a same series link; and
several first signals corresponding to a same first real-time line are applied to inputs of different serializers.

22. The method according to claim 4 wherein
several serializers and several deserializers are connected to a same series link; and
several first signals corresponding to a same first real-time line are applied to inputs of different serializers.

23. The method according to claim 5 wherein
several serializers and several deserializers are connected to a same series link; and
several first signals corresponding to a same first real-time line are applied to inputs of different serializers.

24. The method according to claim 6 wherein
several serializers and several deserializers are connected to a same series link; and
several first signals corresponding to a same first real-time line are applied to inputs of different serializers.

25. The method according to claim 9 wherein
several serializers and several deserializers are connected to a same series link; and
several first signals corresponding to a same first real-time line are applied to inputs of different serializers.

26. The method according to claim 13 wherein
several serializers and several deserializers are connected to a same series link; and
several first signals corresponding to a same first real-time line are applied to inputs of different serializers.

27. An apparatus comprising:
a plurality of routing control lines;
at least one serializer connected to at least one of the control lines;
at least one deserializer connected to at least one of the control lines;
means for serially connecting an output of one of the serializers with an input of one of the deserializers;
means for applying in parallel first-time signals observable on one or more first real-time lines to an input of the one of the serializers;
means for causing one of the serializers to send the first signals, successively in time, in the form of second signals on the means for serially connecting; and
means for causing one of the deserializers to extract the second signals in the form of third signals on second real-time lines.

28. The apparatus according to claim 27 wherein the second signals are sent in a frame of a series signal on the means for serially connecting.

29. The apparatus of claim 28 wherein one of the serializers sends a starting signal and an ending signal in the frame of the means for serially connecting; and
the serializer sends the second signals between the starting signal and the ending signal.

30. The apparatus according to claim 29 wherein the serializer sends the starting signal and/or the ending signal with opposite levels.

31. The apparatus according to claim 29 wherein
different signal levels are imposed inside the starting signal, in imposing half-waves on it; and
for a given shape of this starting signal, a signal duration is measured for it.

32. The apparatus according to claim 30 wherein
different signal levels are imposed inside the starting signal, in imposing half-waves on it; and
for a given shape of this starting signal, a signal duration is measured for it.

33. The apparatus according to claim 31 wherein
a frame duration between two starting signals is measured; and
the number of first signals and third signals transported is measured by the ratio of the frame duration to the signal duration, and the third signals are sent on a number of lines corresponding to this number of signals.

34. The apparatus according to claim 29 wherein the second signals, the starting signal and the ending signal are sent with a same signal duration.

35. The apparatus according to claim 30 wherein the second signals, the starting signal and the ending signal are sent with a same signal duration.

36. The apparatus according to claim 31 wherein the second signals, the starting signal and the ending signal are sent with a same signal duration.

37. The apparatus according to claim 32 wherein the second signals, the starting signal and the ending signal are sent with a same signal duration.

38. The apparatus according to claim 33 wherein the second signals, the starting signal and the ending signal are sent with a same signal duration.

39. The apparatus according to claim 28 wherein the second signals are sent in series in the frame at a frequency of 250 kHz.

40. The apparatus according to claim 29 wherein the second signals are sent in series in the frame at a frequency of 250 kHz.

41. The apparatus according to claim 30 wherein the second signals are sent in series in the frame at a frequency of 250 kHz.

42. The apparatus according to claim 31 wherein the second signals are sent in series in the frame at a frequency of 250 kHz.

43. The apparatus according to claim 32 wherein the second signals are sent in series in the frame at a frequency of 250 kHz.

44. The apparatus according to claim 33 wherein the second signals are sent in series in the frame at a frequency of 250 kHz.

45. The apparatus according to claim 27 wherein
several serializers and several deserializers are connected to a same means for serially connecting; and
several first signals corresponding to a same first real-time line are applied to inputs of different serializers.

46. The apparatus according to claim 29 wherein
several serializers and several deserializers are connected to a same means for serially connecting; and
several first signals corresponding to a same first real-time line are applied to inputs of different serializers.

47. The apparatus according to claim 30 wherein
several serializers and several deserializers are connected to a same means for serially connecting; and
several first signals corresponding to a same first real-time line are applied to inputs of different serializers.

48. The apparatus according to claim 31 wherein
several serializers and several deserializers are connected to a same means for serially connecting; and
several first signals corresponding to a same first real-time line are applied to inputs of different serializers.

49. The apparatus according to claim 32 wherein
several serializers and several deserializers are connected to a same means for serially connecting; and
several first signals corresponding to a same first real-time line are applied to inputs of different serializers.

50. The apparatus according to claim 33 wherein
several serializers and several deserializers are connected to a same means for serially connecting; and
several first signals corresponding to a same first real-time line are applied to inputs of different serializers.

51. The apparatus according to claim 34 wherein
several serializers and several deserializers are connected to a same means for serially connecting; and
several first signals corresponding to a same first real-time line are applied to inputs of different serializers.

52. The apparatus according to claim 35 wherein
several serializers and several deserializers are connected to a same means for serially connecting; and
several first signals corresponding to a same first real-time line are applied to inputs of different serializers.

53. A radiology apparatus comprising:
means for emitting radiation;
means for detecting the radiation;
a plurality of routing control lines;
at least one serializer connected to at least one of the control lines;
at least one deserializer connected to at least one of the control lines;
means for serially connecting an output of one of the serializers with an input of one of the deserializers;
means for applying in parallel first-time signals observable on one or more first real-time lines to an input of the one of the serializers;
means for causing one of the serializers to send the first signals, successively in time, in the form of second signals on the means for serially connecting; and
means for causing one of the deserializers to extract the second signals in the form of third signals on second real-time lines.

54. The apparatus according to claim 53 wherein the second signals are sent in a frame of a series signal on the means for serially connecting.

55. The apparatus of claim 54 wherein one of the serializers sends a starting signal and an ending signal in the frame of the means for serially connecting; and
the serializer sends the second signals between the starting signal and the ending signal.

56. The apparatus according to claim 55 wherein the serializer sends the starting signal and/or the ending signal with opposite levels.

57. The apparatus according to claim 55 wherein
different signal levels are imposed inside the starting signal, in imposing half-waves on it; and
for a given shape of this starting signal, a signal duration is measured for it.

58. The apparatus according to claim 56 wherein
different signal levels are imposed inside the starting signal, in imposing half-waves on it; and
for a given shape of this starting signal, a signal duration is measured for it.

59. The apparatus according to claim 57 wherein
a frame duration between two starting signals is measured; and
the number of first signals and third signals transported is measured by the ratio of the frame duration to the signal duration, and the third signals are sent on a number of lines corresponding to this number of signals.

60. The apparatus according to claim 55 wherein the second signals, the starting signal and the ending signal are sent with a same signal duration.

61. The apparatus according to claim 56 wherein the second signals, the starting signal and the ending signal are sent with a same signal duration.

62. The apparatus according to claim 57 wherein the second signals, the starting signal and the ending signal are sent with a same signal duration.

63. The apparatus according to claim 58 wherein the second signals, the starting signal and the ending signal are sent with a same signal duration.

64. The apparatus according to claim 54 wherein the second signals are sent in series in the frame at a frequency of 250 kHz.

65. The apparatus according to claim 55 wherein the second signals are sent in series in the frame at a frequency of 250 kHz.

66. The apparatus according to claim 56 wherein the second signals are sent in series in the frame at a frequency of 250 kHz.

67. The apparatus according to claim 58 wherein the second signals are sent in series in the frame at a frequency of 250 kHz.

68. The apparatus according to claim 59 wherein the second signals are sent in series in the frame at a frequency of 250 kHz.

69. The apparatus according to claim 60 wherein the second signals are sent in series in the frame at a frequency of 250 kHz.

70. The apparatus according to claim 53 wherein
several serializers and several deserializers are connected to a same means for serially connecting; and
several first signals corresponding to a same first real-time line are applied to inputs of different serializers.

71. The apparatus according to claim 54 wherein
several serializers and several deserializers are connected to a same means for serially connecting; and
several first signals corresponding to a same first real-time line are applied to inputs of different serializers.

72. The apparatus according to claim 55 wherein
several serializers and several deserializers are connected to a same means for serially connecting; and
several first signals corresponding to a same first real-time line are applied to inputs of different serializers.

73. The apparatus according to claim 56 wherein
several serializers and several deserializers are connected to a same means for serially connecting; and
several first signals corresponding to a same first real-time line are applied to inputs of different serializers.

74. The apparatus according to claim 58 wherein
several serializers and several deserializers are connected to a same means for serially connecting; and
several first signals corresponding to a same first real-time line are applied to inputs of different serializers.

75. The apparatus according to claim 59 wherein
several serializers and several deserializers are connected to a same means for serially connecting; and
several first signals corresponding to a same first real-time line are applied to inputs of different serializers.

76. The apparatus according to claim 63 wherein
several serializers and several deserializers are connected to a same means for serially connecting; and
several first signals corresponding to a same first real-time line are applied to inputs of different serializers.

77. The apparatus according to claim 64 wherein
several serializers and several deserializers are connected to a same means for serially connecting; and
several first signals corresponding to a same first real-time line are applied to inputs of different serializers.
